(19) United States
(12) Patent Application Publication
(10) Pub. No.: US 2026/0081351 A1
(43) Pub. Date: Mar. 19, 2026

(54) PHASE SHIFTER AND ANTENNA

(71) Applicant: HUAWEI TECHNOLOGIES CO., LTD., Shenzhen (CN)

(72) Inventors: Gengfei Wu, Shenzhen (CN); Wentao Wu, Shenzhen (CN); Xinming Liu, Xi'an (CN)

(21) Appl. No.: 19/396,473

(22) Filed: Nov. 21, 2025

Related U.S. Application Data
(63) Continuation of application No. PCT/CN2024/073806, filed on Jan. 24, 2024.

(30) Foreign Application Priority Data
May 22, 2023 (CN) 202321250338.3

(51) Int. Cl. H01Q 3/30; H01Q 1/24

(52) U.S. Cl. CPC H01Q 3/30; H01Q 1/246

(57) ABSTRACT

This application provides a phase shifter and an antenna. The phase shifter includes: a support member; a fastener, where the fastener includes a signal input part and a first signal output part that are both fastened to the support member, a spacing exists between the signal input part and the first signal output part, a guide structure is disposed on the first signal output part, and the guide structure has at least two guide surfaces; and a coupling member, where the coupling member includes a first coupling part and a second coupling part disposed on the first coupling part, the first coupling part is rotatably connected to the support member, the first coupling part is coupled to the signal input part, and at least two surfaces of the second coupling part are respectively coupled to the at least two guide surfaces.

### CROSS-REFERENCE TO RELATED APPLICATIONS

This application is a continuation of International Application No. PCT/CN2024/073806, filed on Jan. 24, 2024, which claims priority to Chinese Patent Application No. 202321250338.3, filed on May 22, 2023. The disclosures of the aforementioned applications are hereby incorporated by reference in their entireties.

### TECHNICAL FIELD

This application relates to the field of wireless communication technologies, and in particular, to a phase shifter and an antenna.

### BACKGROUND

In the field of wireless communication, phase shifters disposed in antennas can change phase distribution of the antennas, to adjust radiation patterns of the antennas for adjusting signal coverage. Performance of the phase shifters, as core components of the antennas, determines performance of the antennas, and consequently affects signal coverage of mobile communication and quality of network optimization.

In related technologies, as shown in FIG. 3, a phase shifter 231 includes a first dielectric substrate 31, a second dielectric substrate 32, a fixed strip line 33, a movable strip line (not shown in FIG. 3), and a crimping module 34. The fixed strip line 33 is fastened to the first dielectric substrate 31. The movable strip line is fastened to the second dielectric substrate 32. The movable strip line is coupled to the fixed strip line 33. A signal input from the fixed strip line 33 may be coupled to the movable strip line and output by the movable strip line. When the movable strip line moves relative to the fixed strip line 33, a phase of the signal output by the movable strip line changes. In this way, a phase shift function of the phase shifter 231 can be implemented.

It can be learned from FIG. 3 that both the fixed strip line 33 and the movable strip line are metal lines disposed on a dielectric substrate, and are arranged opposite to each other. It can be learned that coupling between the fixed strip line 33 and the movable strip line is small. During actual production, due to processing errors, a large gap is generated between the fixed strip line 33 and the movable strip line, introducing risks of electrical performance deterioration caused by the increased coupling spacing.

### SUMMARY

To resolve the foregoing technical problem, this application provides a phase shifter and an antenna, to increase coupling between a second coupling part and a first signal output part, so that electrical performance of the phase shifter is more stable.

This application provides a phase shifter, including a support member, a fastener, and a coupling member. The fastener includes a signal input part and a first signal output part that are both fastened to the support member, a spacing exists between the signal input part and the first signal output part, a guide structure is disposed on the first signal output part, and the guide structure has at least two guide surfaces. The coupling member includes a first coupling part and a second coupling part disposed on the first coupling part, the first coupling part is rotatably connected to the support member, the first coupling part is coupled to the signal input part, and at least two surfaces of the second coupling part are respectively coupled to the at least two guide surfaces. It may be understood that coupling of two components may mean that there is a specific distance between the two coupled components, and a signal output by one of the two components may be coupled to the other component.

When the phase shifter operates, an externally input signal may be input to the signal input part. The first coupling part is coupled to the signal input part, so that the externally input signal can be coupled to the first coupling part through the signal input part. The second coupling part is disposed on the first coupling part, so that a signal coupled to the first coupling part can be transmitted to the second coupling part. The at least two surfaces of the second coupling part are respectively coupled to the at least two guide surfaces of the guide structure. In this case, a signal coupled to the second coupling part may be coupled, through the at least two surfaces of the second coupling part and the at least two guide surfaces of the guide structure, to the first signal output part at which the guide structure is located, and the signal is output by the first signal output part.

The at least two surfaces of the second coupling part are respectively coupled to the at least two guide surfaces, so that distances between the at least two surfaces of the second coupling part and the at least two guide surfaces are respectively small. In other words, a distance between one of the at least two surfaces of the second coupling part and one of the at least two guide surfaces is small, and a distance between another surface of the second coupling part and another guide surface is small. In this way, the second coupling part may move relative to the guide structure. The first coupling part is rotatably connected to the support member. When the first coupling part rotates relative to the support member, the second coupling part is driven to move. In addition, in this process, the guide structure may provide a guiding function for the second coupling part. The first signal output part may have two output parts. When the second coupling part moves to different positions of the guide structure, the two output parts of the first signal output part output signals of different phases, to implement a phase shift function of the phase shifter on the signals.

In this application, the at least two surfaces of the second coupling part are respectively coupled to the at least two guide surfaces, and the guide surfaces are located in the first signal output part. In other words, there are at least two surfaces at which the second coupling part is coupled to the first signal output part, so that coupling between the second coupling part and the first signal output part can be increased. During actual production, due to processing errors, a large gap may exist between the two surfaces at which the second coupling part is coupled to the first signal output part. As a result, a portion of signals cannot be coupled from the second coupling part to the first signal output part, thereby affecting electrical performance of the phase shifter. However, in this application, the coupling between the second coupling part and the first signal output part is large, so that impact of the large gap on electrical performance can be reduced. In other words, in this application, electrical performance of the phase shifter can be more stable.

In addition, the coupling between the second coupling part and the first signal output part is increased, so that basic electrical performance can be ensured. There is no need to additionally use a crimping module that maintains the small distances between the at least two surfaces of the second coupling part and the at least two guide surfaces of the first signal output part. This can reduce costs and avoid a case in which rotation of the coupling member is obstructed because the crimping module exerts a large crimping force on the second coupling part.

In addition, in this application, the fastener is fastened to the support member, and the coupling member is rotatably connected to the support member. In this way, through the support member, a function of connecting the fastener to the coupling member can be implemented, and a relative movement between the fastener and the coupling member can be implemented, without disposing a PCB substrate, so that a loss of electrical performance can be reduced. In addition, compared with a phase shifter using a PCB substrate, the phase shifter in this application can reduce costs and reduce energy consumption.

In some possible implementations, the guide structure includes a bottom surface and a first side surface disposed on the bottom surface, the second coupling part includes a bottom surface and a first side surface disposed on the bottom surface, the bottom surface of the second coupling part faces the bottom surface of the guide structure, and the first side surface of the second coupling part faces the first side surface of the guide structure. A distance between the bottom surface of the second coupling part and the bottom surface of the guide structure may be small, and a distance between the side surface of the second coupling part and the first side surface of the guide structure may be small. The second coupling part and the first signal output part may be coupled through the bottom surface of the second coupling part and the bottom surface of the guide structure, and coupled through the side surface of the second coupling part and the first side surface of the guide structure. In this way, double-surface coupling is implemented between the second coupling part and the first signal output part, thereby increasing the coupling between the second coupling part and the first signal output part.

In some possible implementations, both the first side surface of the guide structure and the first side surface of the second coupling part are arc surfaces. In this way, a shape of the first side surface is the same as that of a surface that is of the side surface and that faces the side surface. When the second coupling part rotates with the first coupling part relative to the support member, the second coupling part moves along the guide structure. Configuration of the arc surfaces enables the second coupling part to move more smoothly on the guide structure.

In some possible implementations, the guide structure further includes a second side surface that is disposed on the bottom surface and that is opposite to the first side surface, and the second coupling part is located between the first side surface and the second side surface of the guide structure. The second coupling part may further include a second side surface opposite to the first side surface. In this way, the second coupling part and the first signal output part may be coupled through the bottom surface of the second coupling part and the bottom surface of the guide structure. The second coupling part and the first signal output part may be further coupled through the first side surface of the second coupling part and the first side surface of the guide structure. Additionally, the second coupling part and the first signal output part may be coupled through the second side surface of the second coupling part and the second side surface of the guide structure. Therefore, three-surface coupling can be implemented between the second coupling part and the first signal output part.

In some possible implementations, the guide structure includes a bottom plate and two opposite side plates disposed on the bottom plate, the bottom surface of the guide structure is a surface that is of the bottom plate and that faces the side plates, and the first side surface and the second side surface of the guide structure are opposite surfaces of the two side plates. In addition to the guide structure, the first signal output part may further include two output parts that are disposed opposite to each other, and the guide structure is located between the two output parts. When the first signal output part is manufactured, the two output parts and the bottom plate may be formed by cutting a plate material. The two side plates are welded to two sides of the bottom plate, or the two side plates are fastened to two sides of the bottom plate through a fastener, to manufacture the first signal output part. Alternatively, the first signal output part may be manufactured in an integrated manufacturing manner. It can be learned that the first signal output part has a simple structure and is easy to implement.

In some possible implementations, the guide structure further includes a first extension part, the first extension part is disposed at an end that is of the first side surface of the guide structure and that is away from the bottom surface, and at least a portion of the second coupling part is located between the first extension part and the bottom surface of the guide structure. In this way, the second coupling part and the first signal output part may be coupled to the first extension part through a top surface of the second coupling part. Therefore, multiple-surface coupling can be implemented between the second coupling part and the first signal output part. In addition, the first extension part can further provide better limiting and guiding functions for movement of the second coupling part, to ensure a proper distance between the second coupling part and the bottom surface of the guide structure.

In addition, the guide structure further includes a second extension part, the second extension part is disposed at an end that is of the second side surface of the guide structure and that is away from the bottom surface of the guide structure, and a portion of the second coupling part is located between the second extension part and the bottom surface of the guide structure. In this way, the second coupling part and the first signal output part may be coupled to the second extension part through the top surface of the second coupling part. Therefore, multiple-surface coupling can be implemented between the second coupling part and the first signal output part. In addition, the second extension part can further provide better limiting and guiding functions for movement of the second coupling part, to ensure a proper distance between the second coupling part and the bottom surface of the guide structure.

In some possible implementations, the two side plates include a first side plate and a second side plate, the first side plate is connected to the first extension part, and the second side plate is connected to the second extension part. First slots are disposed on the first extension part, the first side plate, and the bottom plate, there are a plurality of the first slots, second slots are disposed on the second extension part, the second side plate, and the bottom plate, there are a plurality of the second slots, and the plurality of the first slots and the plurality of the second slots are arranged alternately. In other words, slots on two sides of each first slot are second slots, and slots on two sides of each second slot are first slots. After a signal is coupled to the guide structure through the second coupling part, when the signal is transmitted from a position that is on the first signal output part and that is coupled to the second coupling part to the output part, the signal is not transmitted in an extension direction of the bottom surface of the guide structure when being transmitted on the second coupling part, but is transmitted forward in sequence along a physical portion formed between the first slot and the second slot. In this way, a length of an output path may be increased, and a phase shift amount of the phase shifter is further increased. In other words, when a specific phase shift amount needs to be implemented, the solution of this application can reduce a size of the phase shifter and reduce a weight of the phase shifter, thereby reducing costs.

In a possible implementation, the phase shifter further includes an insulation layer wrapping an outer surface of the coupling member. Configuration of the insulation layer allows for coupling between the coupling member and the fastener. In this way, the signal input part may couple, to the first coupling part, a signal output by the signal input part. Similarly, the second coupling part may couple, to the first signal output part, a signal output by the second coupling part.

In another possible implementation, the phase shifter further includes a plurality of insulation parts; a first insulation part of the plurality of insulation parts is disposed on the first coupling part, and at least a portion of the first insulation part extends out of a surface that is of the first coupling part and that faces the signal input part; and a second insulation part of the plurality of insulation parts is disposed on the second coupling part, and at least a portion of the second insulation part extends out of the bottom surface of the second coupling part. In this way, configuration of the first insulation part allows for a specific distance between the first coupling part and the signal input part, thereby implementing coupling between the first coupling part and the signal input part. The signal input part may couple, to the first coupling part, the signal output by the signal input part. Similarly, configuration of the second insulation part enables the second coupling part to couple, to the first signal output part, the signal output by the second coupling part.

In some possible implementations, the coupling member further includes a connection part located between the first coupling part and the second coupling part. The connection part includes a first connection segment close to the first coupling part, a second connection segment close to the second coupling part, and a third connection segment located between the first connection segment and the second connection segment. Both a size of the first connection segment in a first direction and a size of the second connection segment in the first direction are greater than a size of the third connection segment in the first direction, and the first direction is perpendicular to an extension direction of the connection part. In this way, a connection area between the first connection segment and the first coupling part may be increased, and a connection area between the second connection segment and the second coupling part may be increased, so that connection strength between the second connection segment and the second coupling part can be improved.

In some possible implementations, a surface that is of the first coupling part and that is connected to the first connection segment is a planar surface. In this way, the connection area between the first coupling part and the first connection segment may be increased, so that connection strength between the first coupling part and the first connection segment can be improved.

In some possible implementations, the fastener further includes a second signal output part, and the second signal output part is connected to the signal input part. In this way, a desired signal with a phase of 0 may be obtained based on a size of the second signal output part in the first direction.

In some possible implementations, there are at least two first signal output parts, there are at least two second coupling parts, and the at least two first signal output parts are respectively disposed corresponding to the at least two second coupling parts. In this way, a size of each first signal output part may be designed, so that a phase of a signal output by each first signal output part is different, thereby increasing a phase range of a signal output by the phase shifter.

For a material of the support member, in a possible implementation, the material of the support member includes a conductive material; the phase shifter further includes an insulation support frame, and the fastener is fastened to the support member through the insulation support frame. In this way, the support member can provide support for the fastener and the coupling member on the phase shifter, and serve as “ground” for the phase shifter.

In some other possible implementations, the material of the support member is an insulation material; and the phase shifter further includes a conductive part, and the conductive part may be a conductive column, a conductive plate, or the like. The conductive part is fastened to the support member, and the conductive part may serve as “ground” for the phase shifter. A spacing exists between the conductive part and the fastener, and electrical isolation may be implemented between the conductive part and the fastener through air or another insulation structure. Electrical isolation may be implemented between the conductive part and the coupling member through air or another insulation structure.

In some possible implementations, the phase shifter further includes a conductive housing, the conductive housing is disposed on the support member, there is an accommodation space defined between the conductive housing and the support member, and the fastener and the coupling member are located in the accommodation space. In this way, the conductive housing can shield an external interference signal, thereby improving electrical performance and an intermodulation indicator of the phase shifter.

This application further provides an antenna, including a radiating element and the phase shifter in any one of the foregoing embodiments. The radiating element is electrically connected to the phase shifter. The antenna can implement all effects of the phase shifter.

### BRIEF DESCRIPTION OF DRAWINGS

To describe the technical solutions in embodiments of this application more clearly, the following briefly describes the accompanying drawings used in describing embodiments of this application. It is clear that the accompanying drawings in the following descriptions show merely some embodiments of this application, and a person of ordinary skill in the art may still derive other drawings from these accompanying drawings without creative efforts.

FIG. 1 is a diagram of a structure of an antenna feeder system according to an embodiment of this application;

FIG. 2a is a diagram of a structure of an antenna in FIG. 1;

FIG. 2b is a diagram of another structure of an antenna in FIG. 1;

FIG. 3 is a diagram of a structure of a phase shifter in a related technology;

FIG. 4 is a diagram of a disassembled structure of a phase shifter according to a first embodiment of this application;

FIG. 5 is a diagram of a three-dimensional structure of the phase shifter shown in FIG. 4;

FIG. 6 is a diagram of a planar structure of the phase shifter shown in FIG. 5;

FIG. 7a is a diagram of a structure of a fastener in FIG. 6;

FIG. 7b is a diagram of another structure of a fastener in a phase shifter;

FIG. 8 is a diagram of a structure of a coupling member in FIG. 6;

FIG. 9 is a diagram of an assembly structure of a fastener and a coupling member in FIG. 6;

FIG. 10 is a diagram of a three-dimensional structure of a phase shifter according to a second embodiment of this application;

FIG. 11 is a diagram of a planar structure of the phase shifter shown in FIG. 10;

FIG. 12 is a diagram of a planar structure of a phase shifter according to a third embodiment of this application;

FIG. 13 is a diagram of an assembly structure of a fastener and a coupling member in FIG. 12;

FIG. 14 is a schematic three-dimensional view of an assembled structure of a fastener and a coupling member according to a fourth embodiment of this application; and

FIG. 15 is a schematic planar view of an assembled structure of the fastening bracket and the coupling member in FIG. 14.

Reference numerals: 11: antenna; 12: feeder; 13: pole; 14: adjusting bracket; 15: grounding apparatus; 21: radiating array; 211: metal reflector plate; 212: radiating element; 22: calibration network; 23: feed network; 231: phase shifter; 232: filter; 233: combiner; 24: transmission component; 31: first dielectric substrate; 32: second dielectric substrate; 33: fixed strip line; 34: crimping module; 40: support member; 41: conductive part; 50: fastener; 51: signal input part; 52: first signal output part; 521: output part; 53: guide structure; 531: bottom plate; 532: side plate; 5321: first side plate; 5322: second side plate; 533: extension part; 5331: first extension part; 5332: second extension part; 5333: first slot; 5334: second slot; 534: placement space; 535: first side surface; 536: second side surface; 537: bottom surface; 54: second signal output part; 55: central connection part; 551: first through hole; 60: coupling member; 61: first coupling part; 611: second through hole; 612: surface; 62: second coupling part; 621: first side surface; 622: second side surface; 623: end surface; 624: top surface; 625: bottom surface; 63: connection part; 631: first connection segment; 632: second connection segment; 633: third connection segment; 70: insulation support frame; 71: protrusion part; 80: insulation part; 81: first insulation part; 82: second insulation part.

### DESCRIPTION OF EMBODIMENTS

The following clearly and completely describes the technical solutions in embodiments of this application with reference to the accompanying drawings in embodiments of this application. It is clear that the described embodiments are some but not all of embodiments of this application. All other embodiments obtained by a person of ordinary skill in the art based on embodiments of this application without creative efforts shall be within the protection scope of this application.

The term “and/or” in this specification describes only an association relationship between associated objects and indicates that three relationships may exist. For example, A and/or B may indicate the following three cases: Only A exists, both A and B exist, and only B exists, where A and B may be singular or plural. The character “/” generally indicates an “or” relationship between the associated objects. “At least one piece (item)” means one or more, and “a plurality of” means two or more. The expression “at least one of the following items (pieces)” or a similar expression means any combination of these items, including a single item (piece) or any combination of a plurality of items (pieces). For example, at least one of a, b, or c may indicate a, b, c, a and b, a and c, b and c, or a, b, and c, where a, b, and c may be singular or plural.

In the specification and claims in embodiments of this application, the terms “first”, “second”, and so on are intended to distinguish between different objects but do not indicate a particular order of the objects. For example, a first target object, a second target object, and the like are used for distinguishing between different target objects, but are not used for describing a specific order of the target objects.

The terms such as “connection”, “connected”, and the like are used for indicating interworking or mutual interaction between different components, and may include a direct connection or an indirect connection via another component. In addition, the terms “include”, “have”, and any variant thereof are intended to cover non-exclusive inclusion, for example, include a series of steps or units. For example, a method, system, product, or device is not necessarily limited to those steps or units expressly listed, but may include other steps or units not expressly listed or inherent to such a process, method, product, or device. “Upper”, “lower”, “left”, “right”, and the like are used only relative to orientations of components in the accompanying drawings. These directional terms are relative concepts, are used for relative descriptions and clarifications, and may change accordingly based on changes of positions at which the components in the accompanying drawings are placed.

In addition, in embodiments of this application, the word “example” or “for example” is used to represent giving an example, an illustration, or a description. Any embodiment or design scheme described as “example” or “for example” in embodiments of this application should not be explained as being more preferred or having more advantages than another embodiment or design scheme. To be precise, use of the word such as “example” or “for example” is intended to present a relative concept in a specific manner.

In descriptions of embodiments of this application, unless otherwise stated, “a plurality of” means two or more. For example, a plurality of processing units mean two or more processing units, and a plurality of systems mean two or more systems.

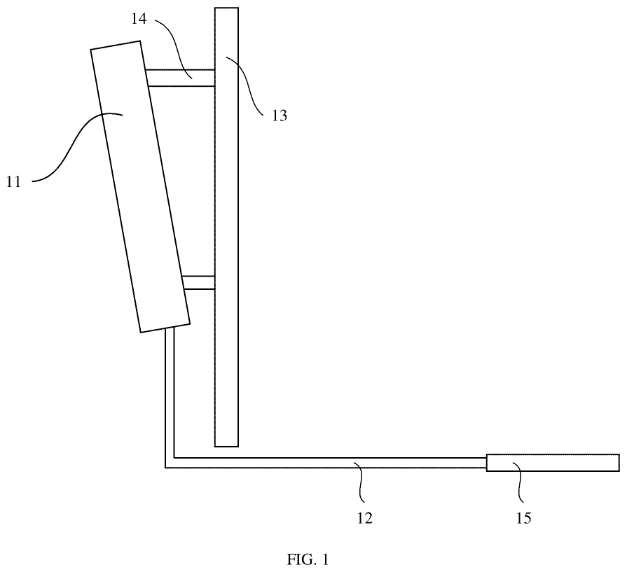

The development of mobile communication is rapidly evolving. With increasing usage of mobile terminals, signal coverage of mobile cellular networks continues to expand. A mobile cellular network may typically include a plurality of base stations, and every two neighboring base stations are in a communication connection and can transmit signals to each other. A base station includes an antenna feeder system. As shown in FIG. 1, the antenna feeder system includes an antenna 11, a feeder 12, a pole 13, an adjusting bracket 14, and a grounding apparatus 15. The antenna 11 may be fastened to the pole 13 through the adjusting bracket 14, and the antenna 11 may be further connected to a main device of the base station through the feeder 12. The antenna 11 may receive a signal sent from another base station, and send the signal to the main device for processing. The antenna 11 may further receive a processed signal sent by the main device, and send the processed signal to another base station. As a key device of the base station, the antenna 11 plays a decisive role in signal coverage of the mobile cellular network. With increasingly complex geographical and electromagnetic radiation environments, performance requirements for the antenna 11 are becoming higher. For instance, there are growing requirements for a higher gain, a lower sidelobe level, and the like of the antenna 11.

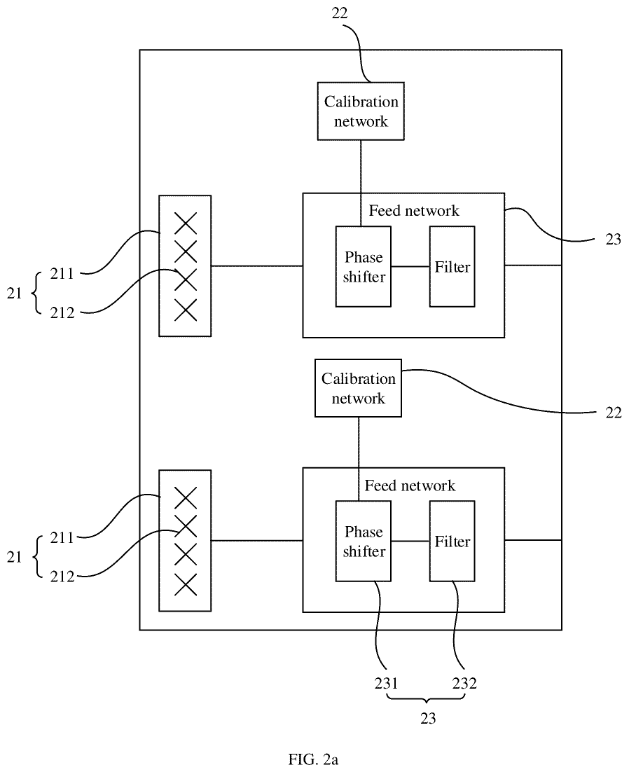

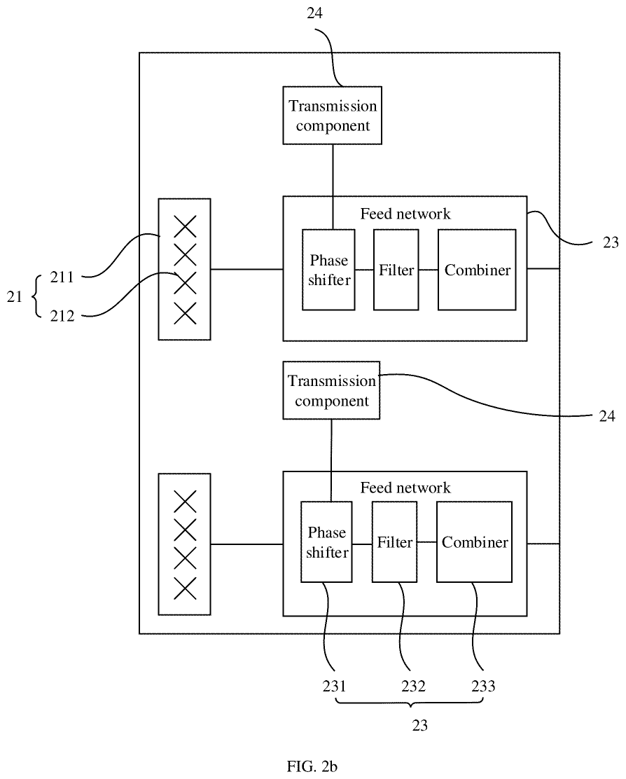

The antenna 11 is typically an electrical tilt antenna capable of adjusting its radiation tilt angle. As shown in FIG. 2a, the antenna 11 usually includes a radome (not shown in FIG. 2a) as well as a plurality of radiating arrays 21, a plurality of calibration networks 22, and a plurality of feed networks 23 that are located within the radome. The plurality of radiating arrays 21, the plurality of feed networks 23, and the plurality of calibration networks 22 are in one-to-one correspondence.

As shown in FIG. 2a, each radiating array 21 includes a metal reflector plate 211 and a plurality of radiating elements 212 fastened to the metal reflector plate 211. The radiating element 212 is configured to receive a signal transmitted by another base station, and transmit a signal to the another base station. In each radiating array 21, radiation frequencies of all radiating elements 212 may be the same; or radiation frequencies of all radiating elements 212 are different; or radiation frequencies of a portion of radiating elements 212 are the same, and radiation frequencies of the other portion of radiating elements 212 are different.

As shown in FIG. 2a, the feed network 23 includes a phase shifter 231 and a filter 232. An end of the filter 232 is electrically connected to the feeder 12 shown in FIG. 1, the other end of the filter 232 is electrically connected to a first end of the phase shifter 231, a second end of the phase shifter 231 is electrically connected to the metal reflector plate 211, and a third end of the phase shifter 231 is electrically connected to the calibration network 22. The radiating array 21 may receive or transmit a signal through the feed network 23. The feed network 23 may obtain a desired calibration signal over the calibration network.

It may be understood that, in another embodiment, as shown in FIG. 2b, the feed network 23 further includes a combiner 233, and the combiner 233 is connected in series between the filter 232 and the feeder 12 shown in FIG. 1. Alternatively, the filter 232 is replaced with the combiner 233. In other words, the feed network 23 includes the phase shifter 231 and the combiner 233 that are connected in series, and the combiner 233 may combine a plurality of received signals of different frequency bands into one signal.

In addition, in another embodiment, as shown in FIG. 2b, the calibration network 22 may be replaced with a transmission component 24, and the feed network 23 may implement different radiation beam directions through the transmission component 24.

Phase distribution of the antenna 11 may be changed through disposition of the phase shifter 231 in the antenna 11, to adjust a radiation pattern of the antenna 11 for adjusting signal coverage. Performance of the phase shifter 231, as a core component of the antenna 11, determines performance of the antenna 11, and consequently affects signal coverage of mobile communication and quality of network optimization.

The phase shifter 231 may be classified into a dielectric phase shifter, a physical phase shifter, and a digital phase shifter. The physical phase shifter is widely used in the antenna 11 due to such features as a small size and a large phase shift amount. With the development of technologies, there are increasingly high requirements for a size and costs of the phase shifter 231, and miniaturization and lightweight become an important design objective for the phase shifter 231.

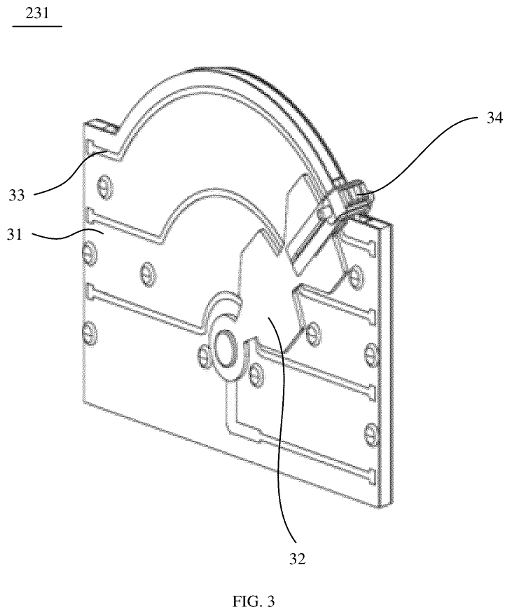

In a related technology, as shown in FIG. 3, a phase shifter 231 includes a first dielectric substrate 31, a second dielectric substrate 32, a fixed strip line 33, a movable strip line (not shown in FIG. 3), and a crimping module 34. The fixed strip line 33 is fastened to the first dielectric substrate 31. The movable strip line is fastened to the second dielectric substrate 32. Both the first dielectric substrate 31 and the second dielectric substrate 32 are PCB boards. The crimping module 34 is connected to the movable strip line, and is configured to secure a distance between the fixed strip line 33 and the movable strip line.

As shown in FIG. 3, the fixed strip line 33 is a metal wire printed on the first dielectric substrate 31. The movable strip line is a metal wire printed on the second dielectric substrate 32. The movable strip line is coupled to the fixed strip line 33. The movable strip line may move relative to the fixed strip line 33.

A signal input from the fixed strip line 33 may be coupled to the movable strip line and output by the movable strip line. When the movable strip line moves relative to the fixed strip line 33, a phase of the signal output by the movable strip line changes. In this way, a phase shift function of the phase shifter 231 can be implemented.

It can be learned from FIG. 3 that both the fixed strip line 33 and the movable strip line are metal lines disposed on a PCB board, and arranged opposite to each other. It can be learned that coupling between the fixed strip line 33 and the movable strip line is small. During actual production, due to processing errors, a large gap is generated between the fixed strip line 33 and the movable strip line, introducing risks of electrical performance deterioration caused by the increased coupling spacing.

Based on this, an embodiment of this application provides a phase shifter 231. The phase shifter 231 allows for more stable electrical performance of the phase shifter 231.

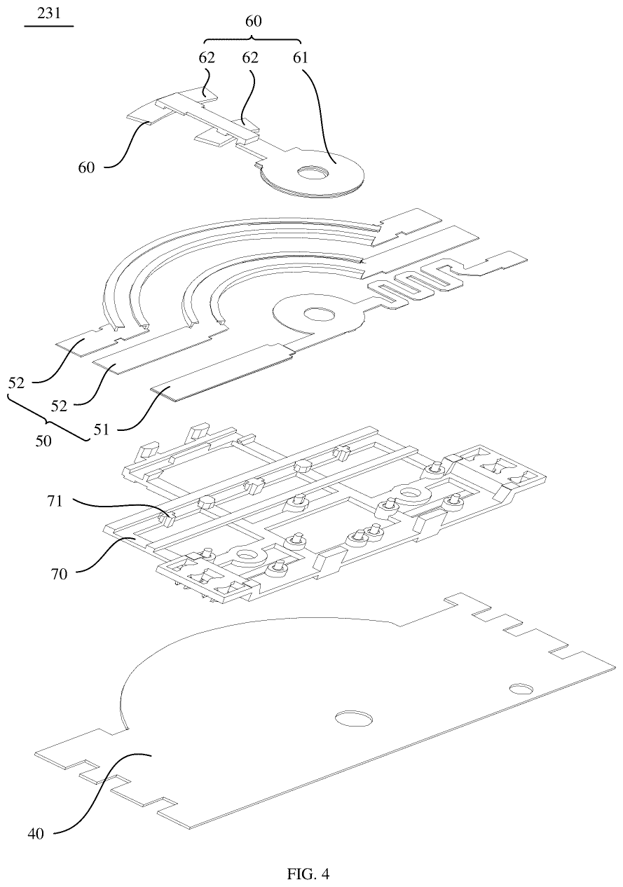

As shown in FIG. 4, the phase shifter 231 may include a support member 40, a fastener 50, and a coupling member 60.

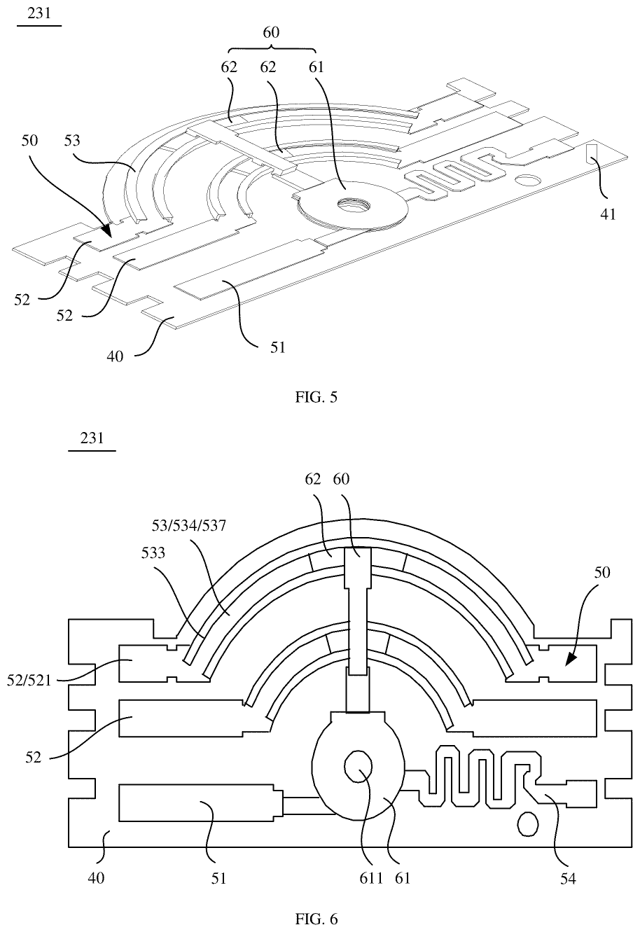

As shown in FIG. 5, the fastener 50 includes a signal input part 51 and a first signal output part 52, and both the signal input part 51 and the first signal output part 52 are fastened to the support member 40. A spacing exists between the signal input part 51 and the first signal output part 52. A guide structure 53 is disposed on the first signal output part 52, and the guide structure 53 has at least two guide surfaces (not shown in FIG. 5).

As shown in FIG. 5, the coupling member 60 includes a first coupling part 61 and a second coupling part 62 disposed on the first coupling part 61. The first coupling part 61 is rotatably connected to the support member 40, and the first coupling part 61 is coupled to the signal input part 51. The at least two surfaces of the second coupling part 62 are respectively coupled to the at least two guide surfaces.

It may be understood that coupling of two components may mean that there is a specific distance between the two coupled components, and a signal output by one of the two components may be coupled to the other component.

When the phase shifter 231 operates, an externally input signal may be input to the signal input part 51. The first coupling part 61 is coupled to the signal input part 51, so that the externally input signal can be coupled to the first coupling part 61 through the signal input part 51. The second coupling part 62 is disposed on the first coupling part 61, so that a signal coupled to the first coupling part 61 can be transmitted to the second coupling part 62. The at least two surfaces of the second coupling part 62 are respectively coupled to the at least two guide surfaces of the guide structure 53. In this case, a signal coupled to the second coupling part 62 may be coupled, through the at least two surfaces of the second coupling part 62 and the at least two guide surfaces of the guide structure 53, to the first signal output part 52 at which the guide structure 53 is located, and the signal is output by the first signal output part 52.

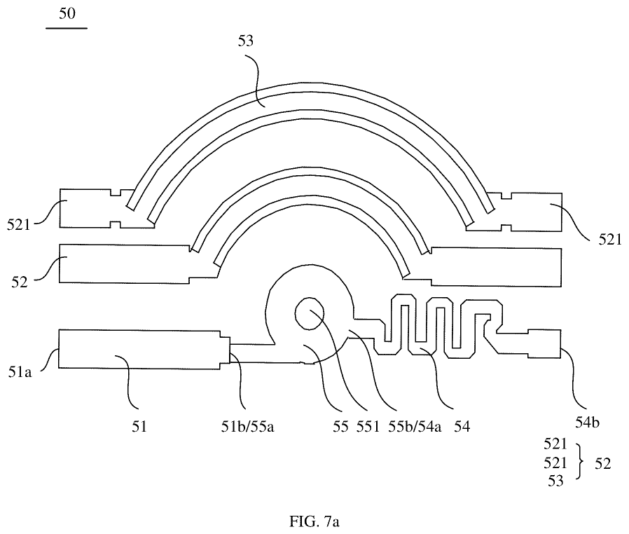

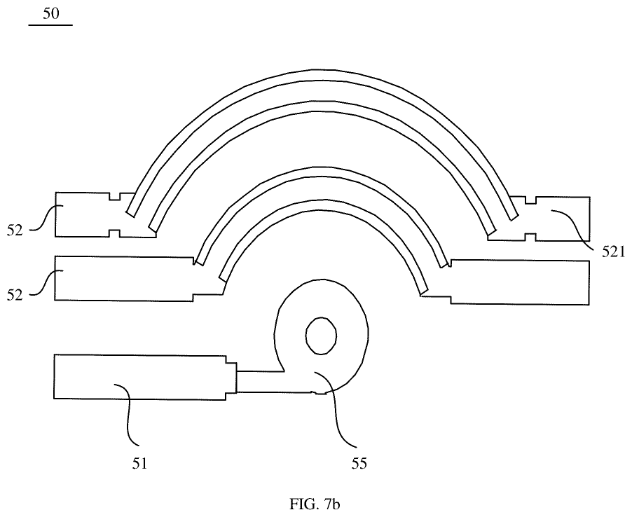

The at least two surfaces of the second coupling part 62 are respectively coupled to the at least two guide surfaces, so that distances between the at least two surfaces of the second coupling part 62 and the at least two guide surfaces are respectively small. In other words, a distance between one of the at least two surfaces of the second coupling part 62 and one of the at least two guide surfaces is small, and a distance between another surface of the second coupling part 62 and another guide surface is small. In this case, the second coupling part 62 may move relative to the guide structure 53. The first coupling part 61 is rotatably connected to the support member 40. When the first coupling part 61 rotates relative to the support member 40, the second coupling part 62 is driven to move. In addition, in this process, the guide structure 53 may provide a guiding function for the second coupling part 62. As shown in FIG. 7a, the first signal output part 52 may have two output parts 521. When the second coupling part 62 moves to different positions of the guide structure 53, the two output parts 521 of the first signal output part 52 output signals of different phases, to implement a phase shift function of the phase shifter 231 on the signals.

In this embodiment of this application, the at least two surfaces of the second coupling part 62 are respectively coupled to the at least two guide surfaces, and the guide surfaces are located in the first signal output part 52. In other words, there are at least two surfaces at which the second coupling part 62 is coupled to the first signal output part 52, so that coupling between the second coupling part 62 and the first signal output part 52 can be increased. During actual production, due to errors, a large gap may exist between two surfaces at which the second coupling part 62 is coupled to the first signal output part 52. As a result, a portion of signals cannot be coupled from the second coupling part 62 to the first signal output part 52, thereby affecting electrical performance of the phase shifter 231. However, in this embodiment of this application, the coupling between the second coupling part 62 and the first signal output part 52 is large, so that impact of the large gap on electrical performance can be reduced. In other words, in this embodiment of this application, stability of the phase shifter 231 for error arising from processing and assembly can be increased, so that electrical performance of the phase shifter 231 can be more stable. In addition, beamforming effect and a scattering parameter of the antenna 11 can be further improved.

It can be learned from FIG. 3 that because coupling between the second coupling part 62 and the first signal output part 52 is small in the related technology, the crimping module needs to be disposed, to ensure that a gap between the second coupling part 62 and the first signal output part 52 is maintained at a size that does not affect electrical performance. This results in high costs of the phase shifter 231 and reliability issues such as an excessively large crimping force caused by the crimping module 34 and adhesion between an insulation layer and the crimping module 34. However, in this embodiment of this application, the coupling between the second coupling part 62 and the first signal output part 52 is increased, so that basic electrical performance can be ensured. There is no need to additionally dispose the crimping module 34 that maintains the small distances between the at least two surfaces of the second coupling part 62 and the at least two guide surfaces of the first signal output part 52. This can reduce costs and avoid a case in which rotation of the coupling member 60 is obstructed because the crimping module 34 exerts a large crimping force on the second coupling part 62.

In addition, in the related technology shown in FIG. 3, the phase shifter includes a PCB substrate, resulting in a high electrical loss. In addition, this incurs high costs, and results in environmental pollution and significant energy consumption. In this embodiment of this application, the fastener 50 is fastened to the support member 40, and the coupling member 60 is rotatably connected to the support member 40. In this way, through the support member 40, a function of connecting the fastener 50 to the coupling member 60 can be implemented, and a relative movement between the fastener 50 and the coupling member 60 can be implemented, without disposing a PCB substrate, so that a loss of electrical performance can be reduced. In addition, compared with the phase shifter 231 using the PCB substrate, the phase shifter 231 in this embodiment of this application can reduce costs and reduce energy consumption.

The following describes in detail the phase shifter 231 in this embodiment of this application.

As shown in FIG. 4, the support member 40 may be a support plate. For a material of the support member 40, in a possible implementation, the material of the support member 40 includes a conductive material. For example, the material of the support member 40 may be metal. In this way, the support member 40 may serve as “ground” for a signal transmission line of the phase shifter 231.

In this case, as shown in FIG. 4, the phase shifter 231 may further include an insulation support frame 70. A material of the insulation support frame 70 is an insulation material. For example, the material of the insulation support frame 70 may be plastic. The fastener 50 may be fastened to the support member 40 through the insulation support frame 70. In other words, the insulation support frame 70 may be fastened to the support member 40. The insulation support frame 70 has a plurality of protrusion parts 71, and the plurality of protrusion parts 71 may be used to fasten the fastener 50 to the insulation support frame 70, so that the fastener 50 is fastened to the support member 40. In this way, the support member 40 can provide support for the fastener 50 and the coupling member 60 on the phase shifter 231, and serve as “ground” for the signal transmission line.

In another possible implementation, the material of the support member 40 is an insulation material. For example, if the material of the support member 40 is plastic, the support member 40 may be a plastic plate. In this case, as shown in FIG. 5, the fastener 50 may be directly fastened to the support member 40.

In this case, as shown in FIG. 5, the phase shifter 231 may further include a conductive part 41, and the conductive part 41 may be a conductive column, a conductive plate, or the like. A material of the conductive part 41 may be metal. The conductive part 41 is fastened to the support member 40, and the conductive part 41 may serve as “ground” for the signal transmission line of the phase shifter 231. A spacing exists between the conductive part 41 and the fastener 50, and electrical isolation may be implemented between the conductive part 41 and the fastener 50 through air or another insulation structure. In addition, a spacing also exists between the conductive part 41 and the coupling member 60, and electrical isolation may be implemented between the conductive part 41 and the coupling member 60 through air or another insulation structure.

In addition, the phase shifter 231 may further include a driving apparatus and a rotating shaft. The rotating shaft is fastened to a driving end of the driving apparatus, and the driving apparatus may drive the rotating shaft to rotate through the driving end.

In this embodiment, as shown in FIG. 7a, in addition to the signal input part 51 and the first signal output part 52, the fastener 50 may further include a second signal output part 54 and a central connection part 55. The signal input part 51, the first signal output part 52, the second signal output part 54, and the central connection part 55 may be metal sheets or metal strips respectively. In another embodiment, as shown in FIG. 7b, the fastener 50 may not include the second signal output part 54, but includes only the signal input part 51, the first signal output part 52, and the central connection part 55.

As shown in FIG. 7a, the signal input part 51 has two ports (51a and 51b), where the port 51a is configured to connect to the feeder 12 in FIG. 1 and receive a signal from the feeder 12. The port 51b may be connected to the central connection part 55, and is configured to output a signal received by an input end to the central connection part 55.

As shown in FIG. 7a, the central connection part 55 has two ports (55a and 55b), where the port 55a may be connected to the signal input part 51 and receive a signal from the signal input part 51. The central connection part 55 is provided with a first through hole 551, the rotating shaft may penetrate the first through hole 551, and a gap exists between the rotating shaft and the first through hole 551. In this way, when the driving apparatus drives the rotating shaft to rotate, the rotating shaft may rotate relative to the central connection part 55.

As shown in FIG. 7a, the second signal output part 54 has two ports (54a and 54b), where the port 54a may be connected to the port 55b of the central connection part 55, and the port 54b may serve as an output port of the phase shifter 231. The second signal output part 54 may receive, through the central connection part 55, a signal output by the signal input part 51 and output the signal. When a phase of a signal required by the radiating element 212 is 0, a size of the second signal output part 54 may be configured, so that a phase of a signal output by the second signal output part 54 is 0.

To reduce a size of the phase shifter 231, as shown in FIG. 7a, an overall shape of the second signal output part 54 may be a rectangular wave shape. This can extend a signal transmission path of the signal in the second signal output part 54.

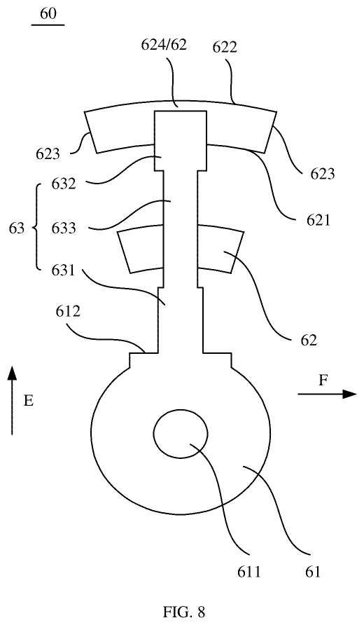

As shown in FIG. 8, in addition to the first coupling part 61 and the second coupling part 62, the coupling member 60 may further include a connection part 63. The connection part 63 is connected between the first coupling part 61 and the second coupling part 62. A material of the coupling member 60 may include a conductive material. For example, the material of the coupling member 60 may include metal. The coupling member 60 may be of an integrated structure, or the coupling member 60 may be made by welding the first coupling part 61, the second coupling part 62, and the connection part 63.

As shown in FIG. 6, the first coupling part 61 is provided with a second through hole 611. The first coupling part 61 is rotatably connected to the support member 40, the first coupling part 61 is disposed opposite to the central connection part 55 (not shown in FIG. 6), and there is a specific distance between the first coupling part 61 and the central connection part 55. The central connection part 55 may couple a signal to the first coupling part 61. Specifically, the first coupling part 61 is provided with the second through hole 611, and the first coupling part 61 is sleeved on and fastened to the rotating shaft through the second through hole 611. In this way, when the rotating shaft is driven to rotate by the driving apparatus, the first coupling part 61 may be driven to rotate synchronously.

As shown in FIG. 8, the connection part 63 includes a first connection segment 631 close to the first coupling part 61, a second connection segment 632 close to the second coupling part 62 that is farther away from the first coupling part 61, and a third connection segment 633 located between the first connection segment 631 and the second connection segment 632. The first connection segment 631, the third connection segment 633, and the second connection segment 632 are disposed in an extension direction E of the connection part 63. A size of the first connection segment 631 in a first direction F is greater than a size of the third connection segment 633 in the first direction F, and a size of the second connection segment 632 in the first direction F is greater than the size of the third connection segment 633 in the first direction F. The first direction F is perpendicular to the extension direction E of the connection part 63. In this way, a connection area between the second connection segment 632 and the second coupling part 62 can be increased, so that connection strength between the second connection segment 632 and the second coupling part 62 can be improved. In addition, a connection area between the first connection segment 631 and the first coupling part 61 can be increased, so that connection strength between the first connection segment 631 and the first coupling part 61 can be improved.

As shown in FIG. 8, a surface 612 that is of the first coupling part 61 and that is connected to the first connection segment 631 is a planar surface. In this way, the connection area between the first coupling part 61 and the first connection segment 631 may be increased, so that connection strength between the first coupling part 61 and the first connection segment 631 can be improved.

There may be one or at least two second coupling parts 62. For example, as shown in FIG. 8, there are two second coupling parts 62, and the two second coupling parts 62 are disposed in the direction E from the first coupling part 61 to the second coupling part 62.

As shown in FIG. 8, the second coupling part 62 includes a bottom surface 625 (not shown in FIG. 8), a first side surface 621, a second side surface 622, two end surfaces 623, and a top surface 624. The top surface 624 is disposed opposite to the bottom surface 625, the first side surface 621 is disposed opposite to the second side surface 622, and the two end surfaces 623 are disposed opposite to each other. The first side surface 621, the second side surface 622, and the two end surfaces 623 are all located between the bottom surface 625 and the top surface 624. The two side surfaces are arranged in the extension direction E of the connection part 63. Both the first side surface 621 and the second side surface 622 are arc surfaces.

As shown in FIG. 8, when there are two second coupling parts 62, a curvature radius of an outer surface that is of the second coupling part 62 and that is farther away from the first coupling part 61 is greater than a curvature radius of an outer surface that is of the second coupling part 62 and that is close to the first coupling part 61.

As shown in FIG. 7a, the first signal output part 52 may include a guide structure 53 and two output parts 521, and the guide structure 53 is located between the two output parts 521. A material of the first signal output part 52 may be a conductive material, for example, metal. In other words, materials of the guide structure 53 and the two output parts 521 may be metal.

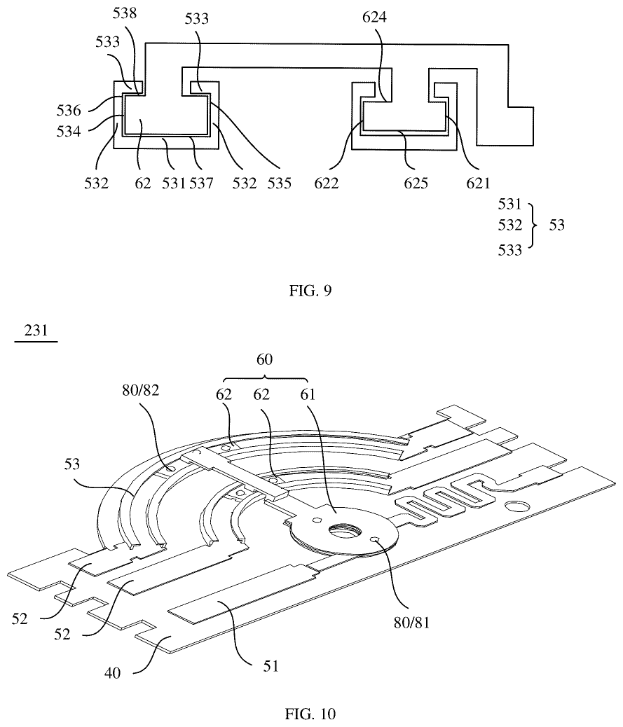

For a structure of the guide structure 53, in a possible implementation, as shown in FIG. 9, the guide structure 53 includes a bottom plate 531, two opposite side plates 532 disposed on the bottom plate 531, and two opposite extension parts 533. The bottom plate 531 has a bottom surface (not shown in FIG. 9), and the two side plates 532 are disposed on two opposite sides of the bottom surface. Opposite surfaces of the two side plates 532 may be referred to as side surfaces. For differentiation, one of the side surfaces may be a first side surface 535, and the other side surface may be a second side surface 536. The extension part 533 is disposed on a side that is of a side surface and that is away from the bottom plate 531, and a gap exists between the two extension parts 533.

As shown in FIG. 9, placement space 534 may be formed between the bottom surface 537, the first side surface 535, the second side surface 536, and the extension part 533 of the guide structure 53, and the second coupling part 62 may be located within the placement space 534. In addition, the bottom surface 625 of the second coupling part 62 faces the bottom surface 537 of the guide structure 53, and a distance between the bottom surface 625 of the second coupling part 62 and the bottom surface 537 of the guide structure 53 may be small. The first side surface 621 of the second coupling part 62 faces the first side surface 535 of the guide structure 53, and a distance between the side surface of the second coupling part 62 and the first side surface 535 of the guide structure 53 is small. The second side surface 622 of the second coupling part 62 faces the second side surface 536 of the guide structure 53, and a distance between the second side surface 622 of the second coupling part 62 and the second side surface 536 of the guide structure 53 is small. The top surface 624 of the second coupling part 62 faces the extension part 533, and distances between the top surface 624 and each of the two extension parts 533 are small.

In this way, as shown in FIG. 9, the second coupling part 62 and the first signal output part 52 may be coupled through the bottom surface 625 of the second coupling part 62 and the bottom surface 537 of the guide structure 53, or may be coupled through the first side surface 621 of the second coupling part 62 and the first side surface 535 of the guide structure 53. In addition, the second coupling part 62 and the first signal output part 52 may be coupled through the second side surface 622 of the second coupling part 62 and the second side surface 536 of the guide structure 53. In addition, the second coupling part 62 and the first signal output part 52 may be further coupled to the two extension parts 533 respectively through the top surface 624 of the second coupling part 62. It can be learned that in this embodiment, multi-surface coupling may be implemented between the second coupling part 62 and the first signal output part 52, thereby further increasing the coupling between the second coupling part 62 and the first signal output part 52.

When the first signal output part 52 shown in FIG. 7a is manufactured, the two output parts 521 and the bottom plate 531 may be formed by cutting a plate material. The two side plates 532 are welded to two sides of the bottom plate 531, or the two side plates 532 are fastened to two sides of the bottom plate 531 through a fastener, to manufacture the first signal output part 52. Alternatively, the first signal output part 52 may be manufactured in an integrated manufacturing manner. It can be learned that the first signal output part 52 has a simple structure and is easy to implement.

In addition, as shown in FIG. 6, when the coupling member 60 is driven by the driving apparatus to rotate around the rotating shaft, the second coupling part 62 moves in the placement space 534 formed by the guide structure 53. The first coupling part 61 may receive a signal coupled from the central connection part 55 (not shown in FIG. 6) and transmit the signal to the second coupling part 62. The second coupling part 62 may couple the signal to the first signal output part 52. When the second coupling part 62 is located at each position of the guide structure 53, the two output parts 521 may output two signals of a same size and with opposite phase directions.

An initial position of the second coupling part 62 may be set, and a phase of a signal output by the output part 521 corresponding to the initial position is set to 0. The second coupling part 62 may be controlled to move to different positions of the guide structure 53, to change the phase of the signal output by the output part 521. In addition, the phase of the signal output by the output part 521 is positively correlated with a displacement of the second coupling part 62 moving from the initial position. For example, a relationship between the phase and the displacement of the signal output by the output part 521 satisfies:

$$φ = \frac{2 π}{λ} Δ L$$

In the equation, φ represents the phase of the signal output by the output part 521, λ represents an operating wavelength of the signal, and ΔL represents the displacement of the second coupling part 62 moving from the initial position. A phase of a signal output by one output part 521 of the first signal output part 52 is +φ, and a phase of a signal output by the other output part 521 is −φ.

The second coupling part 62 may move in the placement space 534 of the guide structure, so that the extension part 533 can further provide better limiting and guiding functions for movement of the second coupling part 62, to ensure a proper distance between the second coupling part 62 and the bottom surface 537.

Both the first side surface 535 and the second side surface 536 of the guide structure 53 are arc surfaces. Both the first side surface 621 and the second side surface 622 of the second coupling part 62 are arc surfaces. Therefore, the first side surface 535 of the guide structure 53 and the first side surface 621 of the second coupling part 62 have a same shape, and the second side surface 536 of the guide structure 53 and the second side surface 622 of the second coupling part 62 have a same shape. When the second coupling part 62 rotates with the first coupling part 61 relative to the support member 40, the second coupling part 62 moves along the guide structure 53. Configuration of the arc surfaces enables the second coupling part 62 to move more smoothly on the guide structure 53.

The first signal output part 52 may output two signals with different phases, and the two output parts 521 of the first signal output part 52 are respectively connected to the radiating elements 212. When phases of radiation signals of the two radiating elements 212 are the same, the two radiating elements 212 may be connected to a same output part 521. When phases of radiation signals of the two radiating elements 212 are different, the two radiating elements 212 may be respectively connected to two different output parts 521. Therefore, a quantity of the first signal output parts 52 may be determined based on a phase requirement of the radiation signal of the radiating element 212 in the radiating array 21. For example, when radiation signals of all radiating elements 212 in a radiating array 21 have phases of +φ, 0, and −φ, there may be one first signal output part 52, the two output parts 521 of the first signal output part 52 may respectively output two signals with phases of +φ and −φ, and the second signal output part 54 may output a signal with a phase of 0. When radiation signals of all radiating elements 212 in a radiating array 21 have phases of +2φ, +φ, 0, −φ, and −2φ, there are two first signal output parts 52, where the two output parts 521 of one of the two first signal output parts 52 may respectively output two signals with phases of +φ and −φ, the two output parts 521 of the other first signal output part 52 may respectively output two signals with phases of +2φ and −2φ, and the second signal output part 54 may output a signal with a phase of 0.

As shown in FIG. 6, a quantity of the second coupling parts 62 is the same as that of the first signal output parts 52. For example, when there is one first signal output part 52, there may be one second coupling part 62. When there are at least two first signal output parts 52, there may be at least two second coupling parts 62. The at least two first signal output parts 52 and the at least two second coupling parts 62 are respectively disposed corresponding to each other. In this way, a size of each first signal output part 52 may be designed, so that a phase of a signal output by each first signal output part 52 is different, thereby increasing a phase range of a signal output by the phase shifter 231.

The phase shifter 231 may further include an insulation layer (not shown in FIG. 6) wrapping an outer surface of the coupling member 60. The insulation layer may allow for coupling between the coupling member 60 and the fastener 50, and the signal input part 51 may couple, to the first coupling part 61, a signal output by the signal input part 51. Similarly, the second coupling part 62 may couple, to the first signal output part 52, a signal output by the second coupling part 62.

It may be understood that distances between the second coupling part 62 of the coupling member 60 and the bottom surface 537, the first side surface 535, and the second side surface 536 of the guide structure 53 are small. When an insulation layer is disposed on the outer surface of the coupling member 60, the insulation layer may contact the bottom surface 537 of the guide structure 53. Due to processing errors, a small gap may exist between the insulation layer and the bottom surface 537 of the guide structure 53.

The phase shifter 231 may further include a conductive housing (not shown in FIG. 6), and a material of the conductive housing may include metal. The conductive housing is disposed on the support member 40, and there is an accommodation space defined between the conductive housing and the support member 40. The fastener 50 and the coupling member 60 are located within the accommodation space. In this way, the conductive housing can shield an external interference signal, thereby improving electrical performance and an intermodulation indicator of the phase shifter 231.

In addition, the phase shifter 231 may further include a filter circuit and a lightning protection circuit (not shown in FIG. 6). The filter circuit may be electrically connected to the signal input part 51. For example, an output end of the filter circuit may be connected to the signal input part 51. The lightning protection circuit may be electrically connected to the central connection part 55 or the second signal output part 54. For example, the lightning protection circuit may be connected between the signal input part 51 and the central connection part 55, or the lightning protection circuit may be connected between the central connection part 55 and the second signal output part 54, or the lightning protection circuit may be connected to an output port of the second signal output part 54.

In another embodiment of this application, a difference from the embodiment shown in FIG. 5 lies in that, in this embodiment, based on the embodiment shown in FIG. 5, the insulation layer is removed, and a plurality of insulation parts 80 are added.

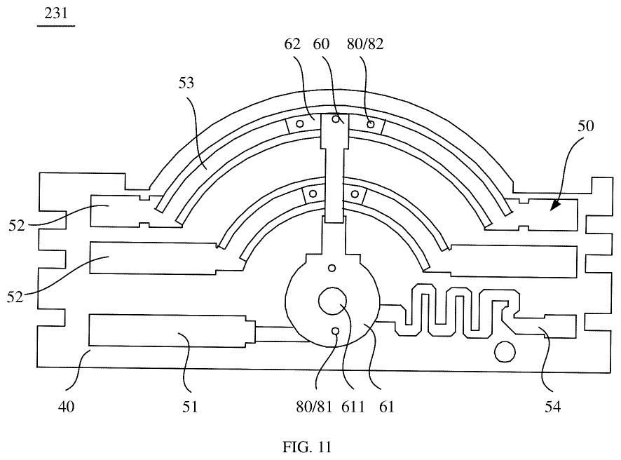

As shown in FIG. 10 and FIG. 11, in this embodiment, a first insulation part 81 of the plurality of insulation parts 80 is disposed on the first coupling part 61, and at least a portion of the first insulation part 81 extends out of a surface that is of the first coupling part 61 and that faces the signal input part 51.

For a structure of the first insulation part 81, in a possible implementation, the first coupling part 61 is provided with a plurality of through holes, a portion of the first insulation part 81 is located within the through holes, and the first insulation part 81 extends out of the surface that is of the first coupling part 61 and that faces the signal input part 51.

In another possible implementation, the first insulation part 81 is disposed on the surface that is of the first coupling part 61 and that faces the signal input part 51. In this way, configuration of the first insulation part 81 allows for a specific distance between the first coupling part 61 and the signal input part 51, thereby implementing coupling between the first coupling part 61 and the signal input part 51. The signal input part 51 may couple, to the first coupling part 61, the signal output by the signal input part.

A second insulation part 82 of the plurality of insulation parts 80 is disposed on the second coupling part 62, and at least a portion of the second insulation part 82 extends out of the bottom surface 625 of the second coupling part 62.

For a structure of the second insulation part 82, in a possible implementation, the second coupling part 62 is provided with a plurality of through holes, a portion of the second insulation part 82 is located within the through holes, and the second insulation part 82 extends out of the bottom surface 625 of the second coupling part 62. Alternatively, the second insulation part 82 extends out of the top surface 624 of the second coupling part 62, and the second insulation part 82 is disposed corresponding to the extension part 533 on the second coupling part 62. Alternatively, two ends of the second insulation part 82 respectively extend from the top surface 624 of the second coupling part 62 and the bottom surface 625 of the second coupling part 62.

In another possible implementation, the second insulation part 82 is disposed on a surface that is of the second coupling part 62 and that faces the bottom surface 537 of the guide structure 53. In this way, configuration of the second insulation part 82 allows for a specific distance between the second coupling part 62 and the first signal input part 51, thereby implementing coupling between the second coupling part 62 and the first signal output part 52. The second coupling part 62 may couple, to the first signal output part 52, the signal output by the second coupling part 62.

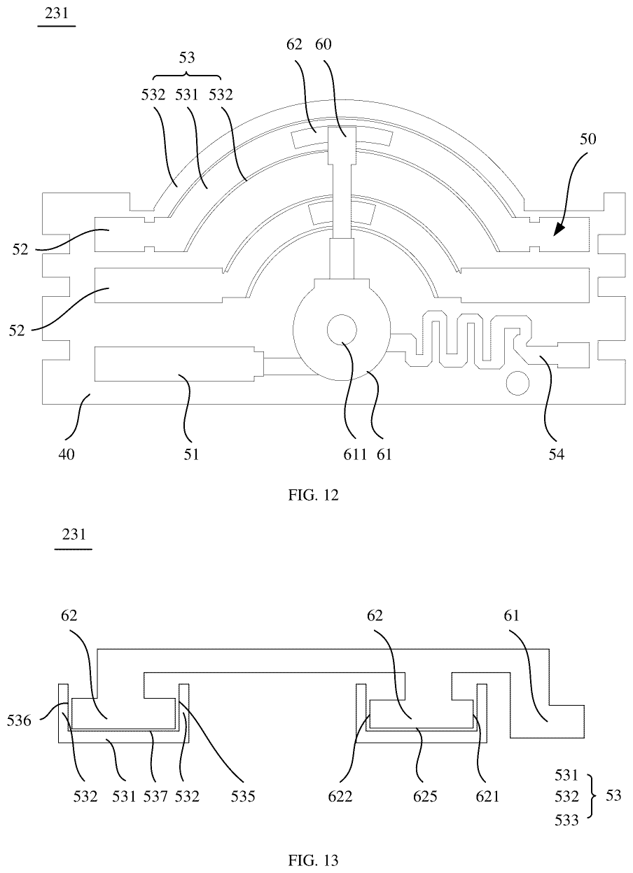

In another embodiment of this application, a difference from the embodiment shown in FIG. 9 lies in that the guide structure 53 is different. In the embodiment shown in FIG. 9, the guide structure 53 includes the bottom plate 531, the two side plates 532, and the two extension parts 533. In this embodiment, as shown in FIG. 12 and FIG. 13, the guide structure 53 includes a bottom plate 531 and two side plates 532, but does not include an extension part 533. In this way, the second coupling part 62 and the first signal output part 52 may be coupled through the bottom surface 625 of the second coupling part 62 and the bottom surface 537 of the guide structure 53. The second coupling part 62 and the first signal output part 52 may be further coupled through the first side surface 621 of the second coupling part 62 and the first side surface 535 of the guide structure 53. Additionally, the second coupling part 62 and the first signal output part 52 may be coupled through the second side surface 622 of the second coupling part 62 and the second side surface 536 of the guide structure 53. Therefore, three-surface coupling can be implemented between the second coupling part 62 and the first signal output part 52.

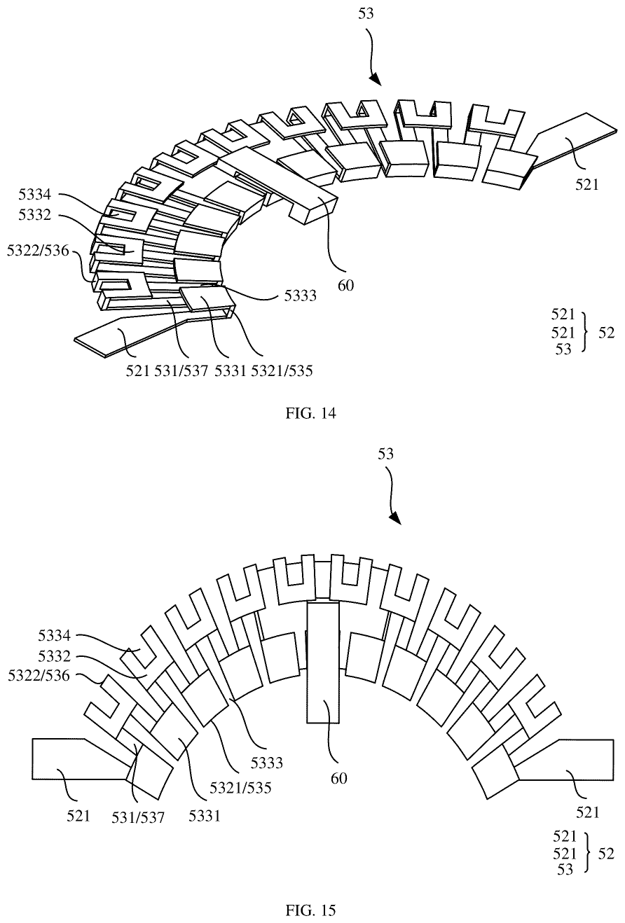

In another embodiment of this application, a difference from the embodiment shown in FIG. 6 lies in that the guide structure 53 is different. In the embodiment shown in FIG. 6, the bottom surface 537, the first side surface 535 (not shown in FIG. 6), the second side surface 536 (not shown in FIG. 6), and surfaces that are of the extension parts 533 and that face the bottom surface 537 of the guide structure 53 are all continuous surfaces. In this embodiment, as shown in FIG. 14 and FIG. 15, the bottom surface 537, the first side surface 535, the second side surface 536, and surfaces that are of the extension parts 533 and that face the bottom surface 537 of the guide structure 53 are all discontinuous surfaces. Specifically, the two side plates 532 include a first side plate 5321 and a second side plate 5322. The two extension parts 533 include a first extension part 5331 and a second extension part 5332. The first side plate 5321 is connected to the first extension part 5331, and the second side plate 5322 is connected to the second extension part 5332. A first slot 5333 is disposed on the first extension part 5331, the first side plate 5321, and the bottom plate 531. In other words, a portion of the first slot 5333 is located on the first extension part 5331, a portion of the first slot 5333 is located on the first side plate 5321, and a remaining portion of the first slot 5333 is located on the bottom plate 531. In addition, there are a plurality of first slots 5333. A second slot 5334 is disposed on the second extension part 5332, the second side plate 5322, and the bottom plate 531. In other words, a portion of the second slot 5334 is located on the second extension part 5332, a portion of the second slot 5334 is located on the second side plate 5322, and a remaining portion of the second slot 5334 is located on the bottom plate 531. There are a plurality of second slots 5334. The plurality of the first slots 5333 and the plurality of the second slots 5334 are arranged alternately. In other words, slots on two sides of each first slot 5333 are second slots 5334, and slots on two sides of each second slot 5334 are first slots 5333. After a signal is coupled to the guide structure 53 through the second coupling part 62, when the signal is transmitted from a position that is on the first signal output part 52 and that is coupled to the second coupling part 62 to the output part 521, the signal is not transmitted in an extension direction of the bottom plate 531 when being transmitted on the second coupling part 62, but is transmitted forward in sequence along a physical portion formed between the first slot 5333 and the second slot 5334. In this way, a length of an output path may be increased, and a phase shift amount of the phase shifter 231 is further increased. In other words, when a specific phase shift amount needs to be implemented, the solution of this embodiment of this application can reduce a size of the phase shifter 231 and reduce a weight of the phase shifter 231, thereby reducing costs.

The foregoing describes embodiments of this application with reference to the accompanying drawings. However, this application is not limited to the foregoing specific implementations. The foregoing specific implementations are merely examples instead of limitations. Inspired by this application, a person of ordinary skill in the art may further make modifications without departing from the purposes of this application and the protection scope of the claims, and all the modifications shall be within the protection of this application.

1. A phase shifter, comprising:
a support member;
a fastener, wherein the fastener comprises a signal input part and a first signal output part that are both fastened to the support member, a spacing exists between the signal input part and the first signal output part, a guide structure is disposed on the first signal output part, and the guide structure has at least two guide surfaces; and
a coupling member, wherein the coupling member comprises a first coupling part and a second coupling part disposed on the first coupling part, the first coupling part is rotatably connected to the support member, the first coupling part is coupled to the signal input part, and at least two surfaces of the second coupling part are respectively coupled to the at least two guide surfaces.

2. The phase shifter according to claim 1, wherein the guide structure comprises a bottom surface and a first side surface disposed on the bottom surface, the second coupling part comprises a bottom surface and a first side surface disposed on the bottom surface, the bottom surface of the second coupling part faces the bottom surface of the guide structure, and the first side surface of the second coupling part faces the first side surface of the guide structure.

3. The phase shifter according to claim 2, wherein both the first side surface of the guide structure and the first side surface of the second coupling part are arc surfaces.

4. The phase shifter according to claim 2, wherein the guide structure further comprises a second side surface that is disposed on the bottom surface of the guide structure and that is opposite to the first side surface of the guide structure, and the second coupling part is located between the first side surface and the second side surface of the guide structure.

5. The phase shifter according to claim 2, wherein the guide structure comprises a bottom plate and two opposite side plates disposed on the bottom plate, the bottom surface of the guide structure is a surface that is of the bottom plate and that faces the side plates, and the first side surface and the second side surface of the guide structure are opposite surfaces of the two side plates.

6. The phase shifter according to claim 5, wherein the guide structure further comprises a first extension part, the first extension part is disposed at an end that is of the first side surface of the guide structure and that is away from the bottom surface of the guide structure, and at least a portion of the second coupling part is located between the first extension part and the bottom surface of the guide structure.

7. The phase shifter according to claim 6, wherein the guide structure further comprises a second extension part, the second extension part is disposed at an end that is of the second side surface of the guide structure and that is away from the bottom surface of the guide structure, and a portion of the second coupling part is located between the second extension part and the bottom surface of the guide structure.

8. The phase shifter according to claim 7, wherein the two side plates comprise a first side plate and a second side plate, the first side plate is connected to the first extension part, and the second side plate is connected to the second extension part; and
first slots are disposed on the first extension part, the first side plate, and the bottom plate, there are a plurality of the first slots, second slots are disposed on the second extension part, the second side plate, and the bottom plate, there are a plurality of the second slots, and the plurality of the first slots and the plurality of the second slots are arranged alternately.

9. The phase shifter according to claim 1, wherein the phase shifter further comprises an insulation layer wrapping an outer surface of the coupling member.

10. The phase shifter according to claim 1, wherein the phase shifter further comprises a plurality of insulation parts; a first insulation part of the plurality of insulation parts is disposed on the first coupling part, and at least a portion of the first insulation part extends out of a surface that is of the first coupling part and that faces the signal input part; and a second insulation part of the plurality of insulation parts is disposed on the second coupling part, and at least a portion of the second insulation part extends out of the bottom surface of the second coupling part.

11. The phase shifter according to claim 1, wherein the coupling member further comprises a connection part located between the first coupling part and the second coupling part, the connection part comprises a first connection segment close to the first coupling part, a second connection segment close to the second coupling part, and a third connection segment located between the first connection segment and the second connection segment, both a size of the first connection segment in a first direction and a size of the second connection segment in the first direction are greater than a size of the third connection segment in the first direction, and the first direction is perpendicular to an extension direction of the connection part.

12. The phase shifter according to claim 11, wherein a surface that is of the first coupling part and that is connected to the first connection segment is a planar surface.

13. The phase shifter according to claim 1, wherein the fastener further comprises a second signal output part, and the second signal output part is connected to the signal input part.

14. The phase shifter according to claim 1, wherein there are at least two first signal output parts, there are at least two second coupling parts, and the at least two first signal output parts are respectively disposed corresponding to the at least two second coupling parts.

15. The phase shifter according to claim 1, wherein a material of the support member comprises a conductive material; and
the phase shifter further comprises an insulation support frame, and the fastener is fastened to the support member through the insulation support frame.

16. The phase shifter according to claim 1, wherein a material of the support member is an insulation material; and the phase shifter further comprises a conductive part, and the conductive part is fastened to the support member.

17. The phase shifter according to claim 1, wherein the phase shifter further comprises a conductive housing, the conductive housing is disposed on the support member, there is an accommodation space defined between the conductive housing and the support member, and the fastener and the coupling member are located in the accommodation space.

18. An antenna, comprising a radiating element and the phase shifter, wherein the radiating element is electrically connected to the phase shifter, and the phase shifter comprises:
a support member;
a fastener, wherein the fastener comprises a signal input part and a first signal output part that are both fastened to the support member, a spacing exists between the signal input part and the first signal output part, a guide structure is disposed on the first signal output part, and the guide structure has at least two guide surfaces; and
a coupling member, wherein the coupling member comprises a first coupling part and a second coupling part disposed on the first coupling part, the first coupling part is rotatably connected to the support member, the first coupling part is coupled to the signal input part, and at least two surfaces of the second coupling part are respectively coupled to the at least two guide surfaces.

19. The antenna accordingly claim 18, wherein the guide structure comprises a bottom surface and a first side surface disposed on the bottom surface, the second coupling part comprises a bottom surface and a first side surface disposed on the bottom surface, the bottom surface of the second coupling part faces the bottom surface of the guide structure, and the first side surface of the second coupling part faces the first side surface of the guide structure.

20. The antenna accordingly claim 19, wherein both the first side surface of the guide structure and the first side surface of the second coupling part are arc surfaces.
